(19) United States
(12) Patent Application Publication
(10) Pub. No.: US 2011/0136434 A1
(43) Pub. Date: Jun. 9, 2011

(54) METHOD AND APPARATUS FOR TRANSMITTING DATA IN BLUETOOTH DEVICES

(75) Inventor: Sung Choon CHOI, Gumi-si (KR)

(73) Assignee: SAMSUNG ELECTRONICS CO. LTD., Suwon-si (KR)

(21) Appl. No.: 12/963,074

(22) Filed: Dec. 8, 2010

(30) Foreign Application Priority Data
Dec. 8, 2009 (KR) 10-2009-0121187

(51) Int. Cl. H04B 7/00

(52) U.S. Cl. 455/41.2

(57) ABSTRACT

A Bluetooth device and a method for transmitting data among Bluetooth devices are provided. The method includes, at a first Bluetooth device, receiving data from a second Bluetooth device with which the first Bluetooth device establishes a Bluetooth connection, at the first Bluetooth device, determining whether a forwarding mode is activated, and if the forwarding mode is activated, transmitting the received data to at least one target Bluetooth device selected depending on preset forwarding information.

### PRIORITY

This application claims the benefit under 35 U.S.C. §119(a) of a Korean patent application filed on Dec. 8, 2009 in the Korean Intellectual Property Office and assigned Serial No. 10-2009-0121187, the entire disclosure of which is hereby incorporated by reference.

### BACKGROUND OF THE INVENTION

1. Field of the Invention

The present invention relates to a method and apparatus for a Bluetooth device. More particularly, the present invention relates to a method and apparatus for transmitting data between Bluetooth devices in order to allow a certain Bluetooth device to forward received data to another Bluetooth device.

2. Description of the Related Art

With recent developments in electronic technology, devices have been developed with a variety of new, advanced and useful functions. One of the useful functions is a Bluetooth function that supports Bluetooth communication. A certain electronic device having the Bluetooth function (hereinafter, referred to as a Bluetooth device) is capable of transmitting and receiving data to and from other Bluetooth devices at a short distance.

In a case of sharing specific data among three or more Bluetooth devices, two of the Bluetooth devices establishes a Bluetooth connection and then perform data communication. Thereafter, one of the above two Bluetooth devices forms a new Bluetooth connection with the third Bluetooth device and then performs data communication.

For example, a data transmitting Bluetooth device transmits data to the first Bluetooth device. In such a case, in order to forward the data to the second Bluetooth device, the transmitting Bluetooth device or the first Bluetooth device should perform a procedure for establishing a Bluetooth connection with the second Bluetooth device from the beginning. Then, through a data communication between the second Bluetooth device and one of the transmitting Bluetooth device and the first Bluetooth device, data sharing is accomplished among three Bluetooth devices.

A conventional data sharing of three or more Bluetooth devices may cause inconvenience to users since it requires many procedures for establishing Bluetooth connections among respective devices. Also, users repeat a manipulation for selecting transmission data after each procedure for a Bluetooth connection. As a result, a large amount of time is consumed in order to wait for authentication between devices as well as Bluetooth connections.

Therefore, a need exists for a method and apparatus for quickly transmitting data between a plurality of Bluetooth devices using Bluetooth communication.

### BRIEF SUMMARY OF THE INVENTION

An aspect of the present invention is to address at least the above-mentioned problems and/or disadvantages and to provide at least the advantages described below. Accordingly, an aspect of the present invention is to provide a data transmission method using Bluetooth communication and also provide a Bluetooth device supporting the data transmission method.

Another aspect of the present invention is to provide a method and apparatus for transmitting data between Bluetooth devices in order to implement a fast and simple data sharing procedure based on Bluetooth communication among a plurality of Bluetooth devices.

In accordance with an aspect of the present invention, a method for transmitting data in Bluetooth devices is provided. The method includes at a first Bluetooth device, receiving at least one data from a second Bluetooth device with which the first Bluetooth device establishes a Bluetooth connection, at the first Bluetooth device, determining whether a forwarding mode is activated, and if the forwarding mode is activated, transmitting the received data to at least one target Bluetooth device selected depending on predetermined forwarding information.

In accordance with another aspect of the present invention, a Bluetooth device is provided. The device includes a Bluetooth module configured to support Bluetooth communication, a memory unit configured to store data received through the Bluetooth module, and a control unit configured to control forwarding the received data to a target Bluetooth device selected depending on predetermined forwarding information in a forwarding mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic view illustrating a communication system composed of a plurality of Bluetooth devices according to an exemplary embodiment of the present invention.

FIG. 2 is a flow diagram illustrating a method for transmitting data among Bluetooth devices according to an exemplary embodiment of the present invention.

FIG. 3 is a block diagram illustrating a configuration of a Bluetooth device according to an exemplary embodiment of the present invention.

FIG. 4 is a flow diagram illustrating a process of data forwarding control by a Bluetooth device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an electronic device (hereinafter, referred to as a Bluetooth device) that supports a Bluetooth function. More particularly, the exemplary embodiments of the present invention provide a method and apparatus for transmitting data in Bluetooth devices in order to implement a fast and simple data sharing procedure among the Bluetooth devices. In the exemplary embodiments of the present invention, the Bluetooth device receives data from another Bluetooth device and then immediately transmits the received data to at least one of the other Bluetooth devices without any authentication procedure.

Hereinafter, a method for transmitting data, a Bluetooth device for supporting the method, and a related system will be described. However, the exemplary embodiments of the present invention are not limited thereto.

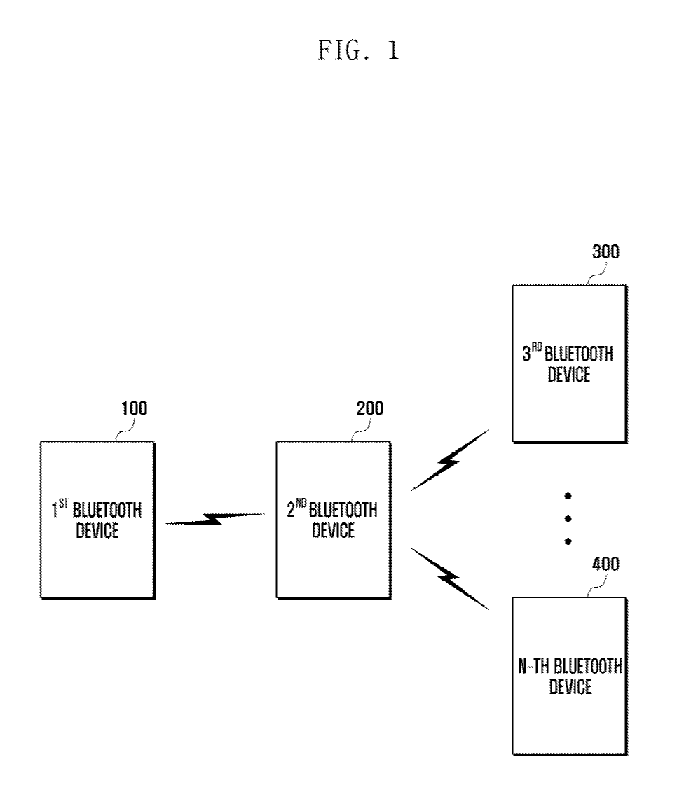

FIG. 1 is a schematic view illustrating a communication system composed of a plurality of Bluetooth devices according to an exemplary embodiment of the present invention.

Referring to FIG. 1, the system includes a plurality of Bluetooth devices such as a first Bluetooth device 100, a second Bluetooth device 200, a third Bluetooth device 300, and an n-th Bluetooth device 400, where n is any integer more than three. The first Bluetooth device 100 has a data source. The second Bluetooth device 200 receives and stores data after establishing a Bluetooth connection with the first Bluetooth device 100. Also, the second Bluetooth device 200 transmits the received data to at least one of the other Bluetooth devices such as the third Bluetooth device 300 and the n-th Bluetooth device 400. The third Bluetooth device 300 and the n-th Bluetooth device 400 both receive and store data the second Bluetooth device 200 transmits. Each of the Bluetooth devices has Bluetooth module for supporting Bluetooth communication.

The first Bluetooth device 100 has at least one data source to be shared with the other Bluetooth devices 200, 300 and 400. Additionally, the first Bluetooth device 100 establishes a Bluetooth connection with a selected one (e.g., the second Bluetooth device 200) of the other Bluetooth devices through an authentication procedure based on Bluetooth communication. Based on the Bluetooth communication, the first Bluetooth device 100 transmits at least one data to the second Bluetooth device 200 in response to a user's request.

The second Bluetooth device 200 establishes a Bluetooth connection with the first Bluetooth device 100 through an authentication procedure based on Bluetooth communication. Additionally, the second Bluetooth device 200 receives and stores at least one data the first Bluetooth device transmits based on Bluetooth communication. More particularly, when data communication with the first Bluetooth device 100 is completed, the second Bluetooth device 200 automatically transmits the received data to the third Bluetooth device 300 and the n-th Bluetooth device 400 according to preset conditions.

More specifically, when finishing a process of receiving data from the first Bluetooth device 100, the second Bluetooth device 200 verifies a setting state of a forwarding mode. If the forwarding mode is activated, the second Bluetooth device 200 selects preset Bluetooth devices that will perform a data forwarding procedure. If several Bluetooth devices are selected, the second Bluetooth device 200 determines priority of each Bluetooth device.

The second Bluetooth device 200 forwards the received data according to the priority. For example, the third Bluetooth device 300 has a preceding priority in comparison with the n-th Bluetooth device 400. Therefore, depending on the priorities of the Bluetooth devices, the second Bluetooth device 200 transmits data to the third Bluetooth device 300 earlier than to the n-th Bluetooth device 400. When data transmission to the third Bluetooth device 300 is completed, the second Bluetooth device 200 begins to transmit data to the n-th Bluetooth device 400 with a next priority. In such a way, data transmission is completed for a certain Bluetooth device with the last priority, and therefore a data forwarding procedure in the forwarding mode is finished.

Data forwarding types in the forwarding mode may include a batch forwarding type and a sequential forwarding type.

The batch forwarding type denotes that the data-receiving Bluetooth device performs sequentially a data forwarding procedure from the Bluetooth device with the first priority to the Bluetooth device with the last priority based on forwarding information, especially, priority information. For example, according to the batch forwarding type, the second Bluetooth device 200 sequentially transmits data, received from the first Bluetooth device 100, to all the other preset Bluetooth devices (e.g., the third Bluetooth device 300 and the n-th Bluetooth device 400), depending on their priorities.

The batch forwarding type is not limited to transmission based on priority information. Alternatively, the batch forwarding type may allow sequential transmission to randomly selected Bluetooth devices. For example, after transmitting data to a certain Bluetooth device selected depending on forwarding information, the data-receiving Bluetooth device selects the next Bluetooth device at random from the other Bluetooth devices and then transmits data to the random-selected Bluetooth device.

The sequential forwarding type denotes that all the preset Bluetooth devices are engaged in performing a data forwarding procedure. More specifically, the data-receiving Bluetooth device transmits data to the Bluetooth device with the first priority, and then the Bluetooth device with the first priority transmits data to the Bluetooth device with the next priority. That is, according to the sequential forwarding type, any Bluetooth device with senior priority performs a data forwarding procedure for a corresponding Bluetooth device with junior priority. For example, the second Bluetooth device 200 receiving data from the first Bluetooth device 100 transmits the received data to the third Bluetooth device 300 with the first priority, and then the third Bluetooth device 300 transmits the received data to the n-th Bluetooth device 400 with the next priority.

In the sequential forwarding type, when transmitting data to the next Bluetooth device, each Bluetooth device may also offer information regarding the order of forwarding. For example, the second Bluetooth device 200 receives data from the first Bluetooth device 100 and also determines priorities of the respective Bluetooth devices that are registered in forwarding information. The second Bluetooth device 200 forwards data to the third Bluetooth device 300 with the first priority. At this time, the second Bluetooth device 200 may also transmit forwarding information having a forwarding order, i.e., priority. Additionally, before transmitting forwarding information, the second Bluetooth device 200 may modify forwarding information by removing items related to the third Bluetooth device 300.

The third Bluetooth device 300 with the first priority receives forwarding information as well as data and, based on the received forwarding information, determines the n-th Bluetooth device 400 with the next priority. Here, the third Bluetooth device 300 may modify forwarding information by removing items related to the n-th Bluetooth device 400. The third Bluetooth device 300 then forwards the received data and the modified forwarding information to the n-th Bluetooth device 400. If the modified forwarding information does not have an item related to the next Bluetooth device, the third Bluetooth device 300 may omit transmitting the modified forwarding information.

The sequential forwarding type is not limited to transmission based on priority information. That is, as described above in the batch forwarding type, the sequential forwarding type may allow sequential transmission to rely on a randomly selection for Bluetooth devices. For example, the data-receiving Bluetooth device selects the next Bluetooth device at random depending on forwarding information and then transmits data and forwarding information to the random-selected Bluetooth device. Similarly, the selected Bluetooth device also selects another Bluetooth device at random and then transmits data and forwarding information to the randomly selected Bluetooth device.

After receiving data and forwarding information, the n-th Bluetooth device 400 determines any Bluetooth device with the next priority, depending on the received forwarding information. If the forwarding information does not have an item related to the next Bluetooth device or if forwarding information is not received, namely if the n-th Bluetooth device 400 is a final destination of data forwarding, the n-th Bluetooth device 400 stores the received data and ends the data forwarding procedure.

Meanwhile, when completely receiving data, each of the third Bluetooth device 300 and the n-th Bluetooth device 400 may transmit a response signal reporting a complete data reception to the second Bluetooth device 200. Alternatively, only the n-th Bluetooth device 400 that is the final destination of data forwarding may transmit the response signal to the second Bluetooth device 200.

The second Bluetooth device 200 receives the response signal from at least one of the other Bluetooth devices and then offers related information, such as information regarding Bluetooth devices transmitting a response signal and information reporting a complete data reception, to users through a display unit.

The third Bluetooth device 300 and the n-th Bluetooth device 400 receive and store data that the second Bluetooth device 200 transmits. If the second Bluetooth device 200 transmits data and forwarding information according to the above-described sequential forwarding type, a selected one of the third Bluetooth device 300 and the n-th Bluetooth device 400 forwards the received data to the next Bluetooth device selected depending on priority in the received forwarding information. That is, if the second Bluetooth device 200 performs a data forwarding procedure according to the sequential forwarding type, the third Bluetooth device 300 or the n-th Bluetooth device 400 also performs a data forwarding procedure according to the sequential forwarding type.

As described above, the first Bluetooth device 100 transmits data to be shared, and the second Bluetooth device 200 establishes a Bluetooth connection with the first Bluetooth device 100 through a given authentication procedure based on Bluetooth communication. The second Bluetooth device 200 then receives data from the first Bluetooth device 100 and stores the received data. Also, the second Bluetooth device 200 forwards the received data to at least one of the other Bluetooth devices preset or selected depending on forwarding information. The other Bluetooth devices receiving data from the second Bluetooth device 200 include the third Bluetooth device 300 and the n-th Bluetooth device 400, where n is any integer more than three.

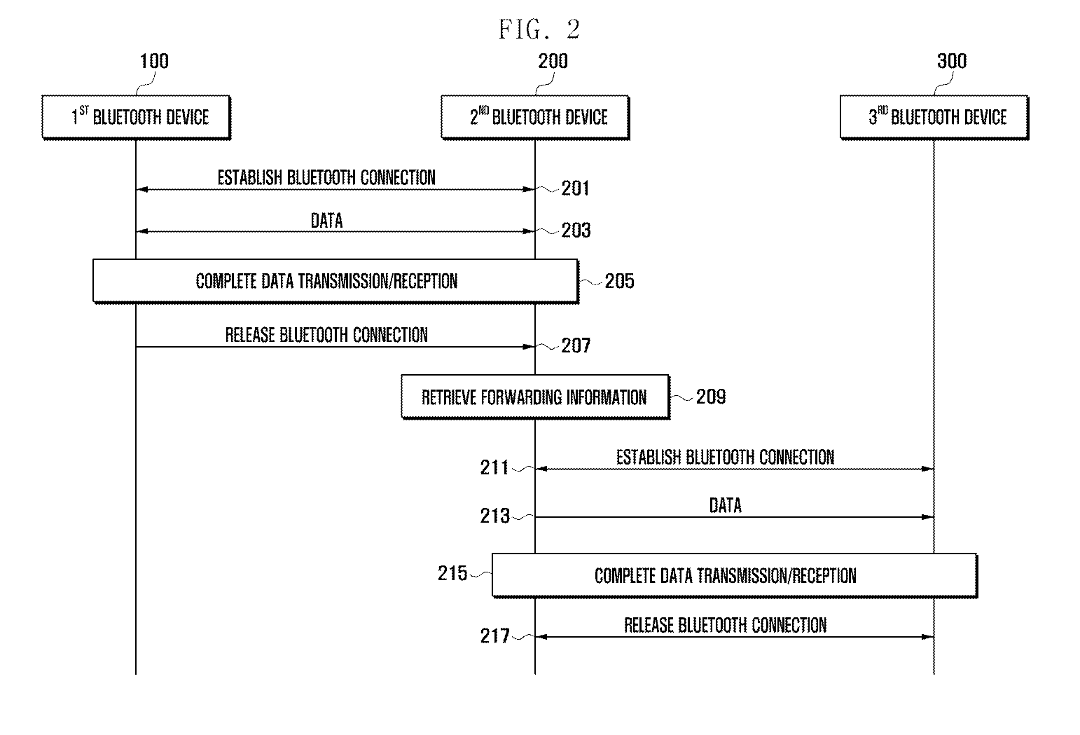

A detailed process performed in a communication system composed of a plurality of Bluetooth devices is described below with reference to FIG. 2.

FIG. 2 is a flow diagram illustrating a method for transmitting data among Bluetooth devices according to an exemplary embodiment of the present invention.

In FIG. 2, it is assumed that a communication system includes three Bluetooth devices, i.e., the first, second and third Bluetooth devices 100, 200 and 300.

Referring to FIG. 2, at an outset, the first Bluetooth device 100 establishes a Bluetooth connection with the second Bluetooth device 200 through an authentication procedure based on Bluetooth communication in response to a user's request in step 201. After a Bluetooth connection is formed, the first Bluetooth device 100 transmits data corresponding to a user's request to the second Bluetooth device 200 through Bluetooth communication in step 203. The second Bluetooth device 200 then receives data from the first Bluetooth device 100 and stores the received data.

After the data is completely transmitted and received between the first Bluetooth device 100 and the second Bluetooth device 200 in step 205, the first Bluetooth device 100 and the second Bluetooth device 200 release a Bluetooth connection in step 207.

After the data is completely received from the first Bluetooth device 100 through the Bluetooth communication and after the Bluetooth connection with the first Bluetooth device 100 is released, the second Bluetooth device 200 retrieves forwarding information in step 209.

Forwarding information may contain a list of other Bluetooth devices. Also, the forwarding information may further contain identification information, priority information and authentication information regarding at least one Bluetooth device in the list. Here, other Bluetooth devices registered in the list refer to at least one candidate for a target to which the second Bluetooth device 200 forwards the received data. Identification information may be the address of the target Bluetooth device, especially, the address of a Bluetooth module (BD_ADDR). If two or more Bluetooth devices are registered in the list, priority information may indicate a target order of data forwarding. Authentication information may be required for establishing a Bluetooth connection between the Bluetooth devices. The second Bluetooth device 200 may directly perform a data forwarding procedure in view of the authentication information without performing a given authentication procedure. In some cases, authentication information may be omitted and, depending on identification information, the second Bluetooth device 200 may forward the received data. Therefore, the forwarding information defined may not always include all of identification information, priority information, authentication information and the like. If the list registers only one Bluetooth device, information may be selectively included, except for the identification information. If the list registers two or more Bluetooth devices, the information may be selectively included, except for the identification information and the priority information. Additionally, if a data forwarding procedure is performed depending on a random selection instead of priority, the priority information may be omitted from the forwarding information.

After retrieving the forwarding information, the second Bluetooth device 200 establishes a Bluetooth connection with the third Bluetooth device 300, depending on the retrieved forwarding information in step 211. In step 211, establishing a Bluetooth connection between the second Bluetooth device 200 and the third Bluetooth device 300 may correspond to forming a data communication channel based on Bluetooth communication without any separate authentication procedure. Therefore, step 211 is exemplary only and may be omitted. Alternatively, the second Bluetooth device 200 may forward data in a unicasting manner, depending on the identification information in the forwarding information.

The second Bluetooth device 200 transmits data, received from the first Bluetooth device 100, to the third Bluetooth device 300 through Bluetooth communication in step 213.

After the data is completely transmitted and received between the second Bluetooth device 200 and the third Bluetooth device 300 in step 215, the second Bluetooth device 200 and the third Bluetooth device 300 release a Bluetooth connection in step 217. In addition, although not illustrated, the third Bluetooth device 300 may transmit a response signal reporting a complete data reception to the second Bluetooth device 200 after completely receiving data in step 215.

After a Bluetooth connection between the second Bluetooth device 200 and the third Bluetooth device 300 is released, the second Bluetooth device 200 may further perform a data forwarding procedure for any other Bluetooth device. Namely, in a case of adopting the above-described batch forwarding type, the second Bluetooth device 200 forwards data to the next Bluetooth device if there is any other target Bluetooth device indicated by forwarding information.

Otherwise, in a case of adopting the above-described sequential forwarding type, the third Bluetooth device 300 may perform a data forwarding procedure for the next Bluetooth device based on the forwarding information. In this case, the second Bluetooth device 200 may modify the forwarding information by removing the identification information regarding the third Bluetooth device 300. The second Bluetooth device 200 may then transmit the modified forwarding information to the third Bluetooth device 300.

The second Bluetooth device 200 is described above as a representative of Bluetooth devices according to an exemplary embodiment of the present invention. The Bluetooth devices are, however, exemplary only and not limited thereto.

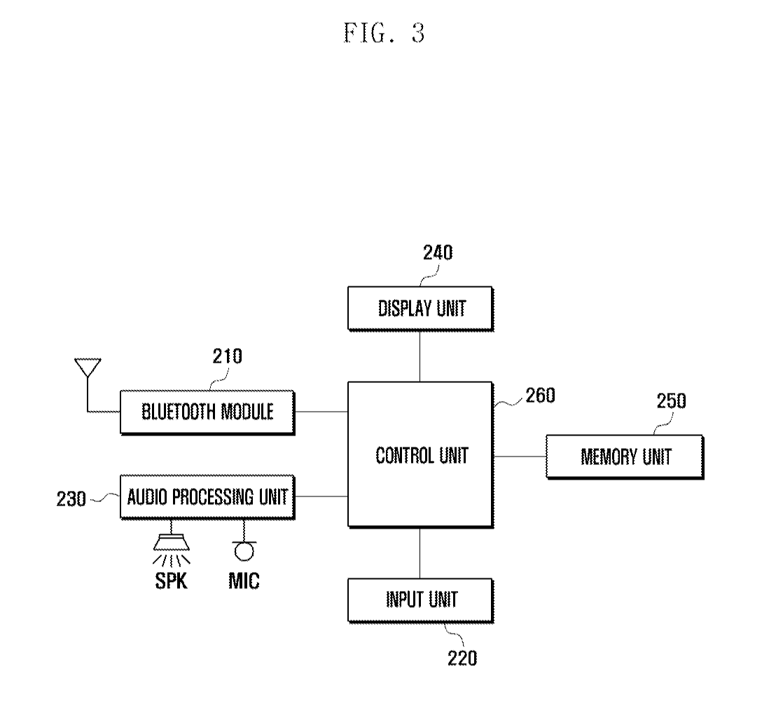

FIG. 3 is a block diagram illustrating a configuration of a Bluetooth device according to an exemplary embodiment of the present invention.

Referring to FIG. 3, the Bluetooth device includes a Bluetooth module 210, an input unit 220, an audio processing unit 230, a display unit 240, a memory unit 250, and a control unit 260. The audio processing unit 230 may have a Speaker (SPK) and a Microphone (MIC).

The Bluetooth module 210 supports Bluetooth communication of the Bluetooth device. The Bluetooth module 210 establishes a Bluetooth communication channel with other Bluetooth device under the control of the control unit 260 and then processes transmission and reception of various data. The Bluetooth module 210 performs the Bluetooth communication based on a Bluetooth protocol with other Bluetooth devices through a Bluetooth antenna. The Bluetooth module 210 stores a host stack for managing the Bluetooth communication, a Bluetooth profile being selectable according to functions or conditions of an external target Bluetooth device, and a related application. For this, the Bluetooth module may have a separate memory unit therein. The Bluetooth profile may be selected among a Hands-Free Profile (HFP) for supporting hands-free sets, a Head-Set Profile (HSP) for supporting headsets, and a Cordless Telephone Profile (CTP) for supporting cordless phones, depending on external Bluetooth devices.

The input unit 220 creates an input signal for entering letters and numerals and an input signal for setting or controlling functions of the Bluetooth device, and then delivers the input signals to the control unit 260. The input unit 220 includes a plurality of input keys and function keys to create the input signals. The function keys may have navigation keys, side keys, shortcut keys e.g., a key for activating a Bluetooth function, and any other special keys defined to perform particular functions. The input unit 220 may be formed of one or a combination of a touchpad, a touch screen, a keypad having a normal key layout (e.g., 3*4 or 4*3 key layout), a keypad having a QWERTY key layout. More particularly, the input unit 220 may create input signals corresponding to a selection of a menu related to a Bluetooth function, a request for a Bluetooth connection, and the like, and then transmit the input signals to the control unit 260. The input signals may be created in the form of a key press signal on a keypad or a touch signal on a touchpad or touch screen.

The audio processing unit 230 may include a SPK for outputting audio signals of the Bluetooth device and a MIC for collecting audio signals such as a user's voice. The audio processing unit 230 converts an audio signal received from the MIC into data and then outputs the data to the control unit 260, and also outputs an audio signal input from the control unit 260 through the SPK. Additionally, the audio processing unit 230 may output various audio components produced in the Bluetooth device, depending on a user's selection. Audio components may include audio signals produced by an audio data playback, sound effects indicating a forwarding function execution, and sound effects indicating a response signal reception from other Bluetooth devices.

The display unit 240 represents a variety of information input by a user or offered to a user, including various screens activated by execution of functions of the Bluetooth device. For example, the display unit 240 may visually output a boot screen, an idle screen, a menu screen, a list screen, a data communication execution screen, an application execution screen, a Bluetooth connection screen, a response signal reception screen, and the like. Namely, the display unit 240 may offer various screen views related to states and operations of the Bluetooth device. The display unit 240 may be formed of a Liquid Crystal Display (LCD), a Plasma Display Panel (PDP), a Light Emitting Diode (LED), an Organic LED (OLED), an Active Matrix OLED (AMOLED), and the like. In addition, the display unit 240 may be formed of a touch screen that functions together as input and output units. In this case, the separate input unit 220 may be omitted from the Bluetooth device. More particularly, the display unit 240 may display a menu screen related to a setting of a Bluetooth connection, a screen related to a list of searched Bluetooth devices, a screen related to a setting of forwarding information, and the like.

The memory unit 250 stores a variety of data and applications created and used in the Bluetooth device, including data produced when a particular function of the Bluetooth device is performed (e.g., video data, audio data, broadcast data, photo data, message data, document data, image data, and the like), data created using the Bluetooth device or received from other entities (e.g., external devices, web servers, personal computers, and the like), applications required for performing particular functions or menus of the Bluetooth device, and the like.

Additionally, the memory unit 250 may store software related to a forwarding function. The memory unit 250 may store forwarding information created based on a forwarding function. Here, the forwarding information may contain identification information (e.g., BD_ADDR), priority information, authentication information, and the like. Also, the memory unit 250 may store various setting information related to Bluetooth communication of the Bluetooth device. The setting information may contain information regarding which forwarding type is determined in a forwarding mode, namely, which one of a batch forwarding type and a sequential forwarding type is determined.

Furthermore, the memory unit 250 may include at least one buffer that temporarily store data produced while functions of the Bluetooth device are performed. For example, the memory unit 250 may perform a buffering for data received under the control of the control unit 260. The memory unit 250 may be internally formed in the Bluetooth device or externally attached such as a smart card. Various kinds of internal/external storages may be used for the memory unit 250, such as a Random Access Memory (RAM), a Read Only Memory (ROM), a flash memory, a multi-chip package memory, and the like.

The control unit 260 performs control functions for the Bluetooth device and also controls the flow of signals in respective elements of the Bluetooth device. That is, the control unit 260 controls the signal flow among the Bluetooth module 210, the input unit 220, the audio processing unit 230, the display unit 240, and the memory unit 250.

Additionally, the control unit 260 controls a series of operations in connection with Bluetooth communication with other Bluetooth device. For example, the control unit 260 may control a given authentication procedure for a Bluetooth connection with other Bluetooth device.

More particularly, the control unit 260 supports a data transmission based on the above-described data forwarding. The forwarding-based data transmission refers to a specific transmission type in which data received from a certain Bluetooth device is directly transmitted to other Bluetooth devices without any separate authentication procedure.

More specifically, the control unit 260 controls a process of establishing a Bluetooth connection in response to a request for a Bluetooth connection by any other Bluetooth devices. Additionally, the control unit 260 controls a process of receiving data transmitted by other Bluetooth devices through Bluetooth communication. Here, the control unit 260 may determine whether a forwarding mode is activated. In a case of an activated forwarding mode, the control unit 260 determines a target Bluetooth device to which the received data will be forwarded, depending on forwarding information preset in the memory unit 250. The control unit 260 then controls a process of forwarding the received data to the target Bluetooth device. Here, the control unit 260 omits conventional procedures for searching and authenticating other Bluetooth devices and instead, depending on the forwarding information, especially, identification information, controls data forwarding toward the target Bluetooth device.

Meanwhile, if a forwarding mode is set to a batch forwarding type, the control unit 260 controls sequential data forwarding to respective Bluetooth devices according to forwarding priority. After completely performing a data forwarding procedure for a specific Bluetooth device with the first priority, the control unit 260 releases a Bluetooth connection with the first-priority Bluetooth device and then controls a data forwarding procedure for other Bluetooth devices with the next priority. When the data forwarding procedure is completed for all Bluetooth devices registered in the forwarding information, the control unit 260 ends the forwarding procedure.

If a forwarding mode is set to a sequential forwarding type, the control unit 260 controls a data forwarding procedure for a specific Bluetooth device with the first priority. Here, the control unit 260 may also transmit forwarding information to the first-priority Bluetooth device after removing identification information regarding the first-priority Bluetooth device from the forwarding information. The control unit 260 ends the forwarding procedure when completely performing a data forwarding procedure for the first-priority Bluetooth device.

As described above, the control unit 260 controls operations in connection with data forwarding functions according to an exemplary embodiment of the present invention. Also, the above-described control functions of the control unit 260 may be implemented as software having a proper algorithm that is executed by the control unit 260.

The Bluetooth device is not limited to the configuration illustrated in FIG. 3. For example, the control unit 260 of the Bluetooth device may have a baseband module used for a mobile communication service, and the Bluetooth device may further include a wireless communication module.

In addition, although not illustrated in FIG. 3, the Bluetooth device of this invention may essentially or selectively include any other elements such as a projector module, a location based service module such as a GPS module, a camera module, a wired or wireless data transmission interface, an Internet access module, a digital broadcast receiving module, and the like. According to a digital convergence tendency, such elements may be varied, modified and improved in various ways, and any other elements equivalent to the above described elements may be additionally or alternatively equipped in the Bluetooth device. Meanwhile, as will be understood by those skilled in the art, some of the above-mentioned elements in the Bluetooth device may be omitted or replaced with other elements.

The exemplary embodiments of the present invention may be applied to various kinds of electronic devices each of which supports a Bluetooth communication function. The electronic devices may include communication devices, multimedia players and their application equipment, including a mobile device having a relatively small display unit and a display device having a relatively large display unit.

The mobile device may include various types of mobile communication terminals based on various communication protocols, a Portable Multimedia Player (PMP), a digital broadcasting player, a Personal Digital Assistant (PDA), a music player (e.g., an MP3 player), a portable game console, a smart phone, a tablet PC, and the like. Meanwhile, the display device may include a Television (TV), a notebook, a personal computer, a Large Format Display (LFD), a Digital Signage (DS), a media pole, and the like.

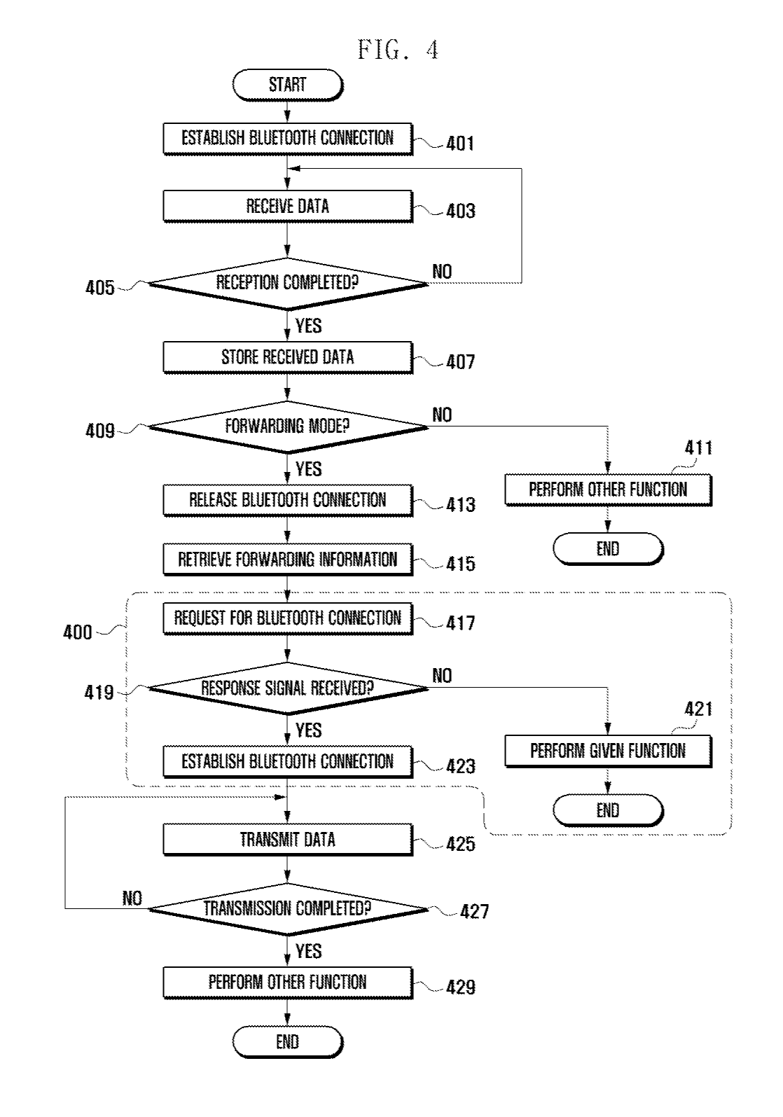

A method for supporting the above-described functions of the Bluetooth device is described with reference to FIG. 4. However, the functions are exemplary only and not limited thereto.

FIG. 4 is a flow diagram illustrating a process of data forwarding control by a Bluetooth device according to an exemplary embodiment of the present invention.

Referring to FIG. 4, at an outset, the control unit 260 of the Bluetooth device establishes a Bluetooth connection with a certain Bluetooth device requesting a Bluetooth connection according to a given authentication procedure based on Bluetooth communication in step 401.

The control unit 260 receives data from the connected Bluetooth device by controlling the Bluetooth module 210 in step 403. The control unit 260 then determines whether data is completely received in step 405. That is, the control unit 260 continuously controls a data receiving process until data is completely received. When a data reception is completed, that is, when a data communication with the connected Bluetooth device is completed, the control unit 260 stores the received data in the memory unit 250 in step 407.

The control unit 260 determines whether a forwarding mode is activated in step 409. Step 409 is optional and therefore may be omitted. For example, a forwarding mode may be activated in advance through a setting of forwarding information before a Bluetooth connection is established.

If a forwarding mode is not activated, the control unit 260 performs any other particular function in step 411. For example, in step 411, the control unit 260 may control a reception of other data from the connected Bluetooth device or may release a Bluetooth connection from the connected Bluetooth device.

If a forwarding mode is activated, the control unit 260 releases a Bluetooth connection from the connected Bluetooth device in step 413. The control unit 260 then retrieves preset forwarding information from the memory unit 250 in step 415. Step 415 may correspond to retrieving identification information regarding a target Bluetooth device to which the received data will be forwarded. Also, if two or more Bluetooth devices are registered in the forwarding information, step 415 may be included in another step that determines respective forwarding priorities of the registered Bluetooth devices.

The control unit 260 transmits a request for a Bluetooth connection to a target Bluetooth device selected depending on the retrieved forwarding information in step 417. The control unit 260 then determines whether a response signal is received from the target Bluetooth device in step 419.

If there is no response signal, the control unit 260 performs any given particular function in step 421. For example, in step 421, the control unit 260 may transmit a request again for a Bluetooth connection to the target Bluetooth device, depending on a given time count or iteration count. If the control unit 260 does not receive a response signal within a given time count or iteration count, the control unit 260 ends the data forwarding procedure and also displays an error message on the display unit 240.

If a response signal is received from the target Bluetooth device, the control unit 260 establishes a Bluetooth connection with the target Bluetooth device in step 423. In step 423, a conventional authenticating procedure based on Bluetooth communication is not performed between both Bluetooth devices. The control unit 260 then forwards the received data to the target Bluetooth device by controlling the Bluetooth module 210 in step 425.

Meanwhile, the above-described steps 417 to 423, also indicated by a reference number 400, are exemplary only and may be omitted if necessary. That is, the step 425 may be performed directly after step 415. More specifically, the control unit 260 may control forwarding of the received data, referring to identification information regarding Bluetooth devices registered in the retrieved forwarding information. That is, the control unit 260 may control a data forwarding procedure in a unicasting manner, using identification information.

The control unit 260 determines whether data is completely forwarded in step 427. If data is not completely forwarded, the control unit 260 returns to the step 425 and continues to control the data forwarding procedure.

If data is completely forwarded, the control unit 260 performs any other particular function in step 429. For example, if there is any additional target Bluetooth devices to which data will be forwarded, the control unit 260 may control a series of operations to forward data to the next-priority Bluetooth device. Then the control unit 260 may then end forwarding control when a given data forwarding procedure is completed, and may also control displaying a screen again before the data forwarding procedure.

The exemplary embodiments of the present invention provide a method and apparatus for transmitting data in Bluetooth devices to implement fast and simple data sharing among several Bluetooth devices. According to the exemplary embodiments of the present invention, one Bluetooth device that receives data from another Bluetooth device immediately transmits the received data to at least one of the other Bluetooth devices without any authentication procedure. That is, in a case where three or more Bluetooth devices try to share data, an authentication procedure is required only once and therefore a data forwarding procedure becomes fast and simple.

The above-described methods according to exemplary embodiments of the present invention can be implemented in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an Application Specific Integrated Circuit (ASIC) or a Field Programmable Gate Array (FPGA). As would be understood in the art, the computer, the processor or the programmable hardware include memory components, e.g., RAM, ROM, Flash, and the like that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been shown and described with reference to an exemplary embodiment thereof, it will be understood by those skilled in the art that various changes in form and details may be made therein without departing from the spirit and scope of the invention as defined by the appended claims and their equivalents.

What is claimed is:

1. A method for transmitting data in Bluetooth devices, the method comprising:
at a first Bluetooth device, receiving data from a second Bluetooth device with which the first Bluetooth device establishes a Bluetooth connection;
at the first Bluetooth device, determining whether a forwarding mode is activated; and
if the forwarding mode is activated, transmitting the received data to at least one target Bluetooth device selected depending on preset forwarding information.

2. The method of claim 1, wherein the transmitting of the received data to at least one target Bluetooth device comprises:
retrieving identification information regarding the target Bluetooth device to which the received data will be forwarded; and
forwarding the received data to the target Bluetooth device indicated by the retrieved identification information.

3. The method of claim 2, wherein the retrieving of the identification information comprises:
if the identification information regarding at least two target Bluetooth devices is retrieved from the forwarding information, at least one of assigning priority to each target Bluetooth device and selecting one of the target Bluetooth devices at random.

4. The method of claim 3, wherein the determining of whether a forwarding mode is activated includes determining a forwarding type based on the forwarding mode,
and wherein the forwarding of the received data includes transmitting the data to at least one of the target Bluetooth device with a first priority and the target Bluetooth device selected at random according to the forwarding type.

5. The method of claim 4, wherein, if the forwarding type is a batch forwarding type, the forwarding of the received data includes sequentially transmitting the data to the target Bluetooth devices from one target Bluetooth device with the first priority to another target Bluetooth device with the last priority, depending on the forwarding information.

6. The method of claim 4, wherein, if the forwarding type is a batch forwarding type, the forwarding of the received data includes sequentially forwarding the data to the target Bluetooth devices selected at random.

7. The method of claim 4, wherein, if the forwarding type is a sequential forwarding type, the forwarding of the received data includes:
forwarding the data to one target Bluetooth device with senior priority; and
at the target Bluetooth device with the senior priority, forwarding the data to other target Bluetooth device with junior priority.

8. The method of claim 4, wherein, if the forwarding type is a sequential forwarding type, the forwarding of the received data includes:
forwarding the data to one target Bluetooth device selected at random among the target Bluetooth devices registered in the forwarding information; and
at the selected target Bluetooth device, forwarding the data to another target Bluetooth device reselected at random among the registered target Bluetooth devices except the selected target Bluetooth device.

9. The method of claim 2, wherein the transmitting of the received data is performed without an authentication procedure based on Bluetooth communication for the target Bluetooth device.

10. The method of claim 2, further comprising:
at the first Bluetooth device, releasing the Bluetooth connection from the second Bluetooth device;
transmitting a request for a new Bluetooth connection to a specific Bluetooth device selected depending on the forwarding information; and
forwarding the received data to the specific Bluetooth device when receiving a response signal from the specific Bluetooth device.

11. A Bluetooth device, the device comprising:
a Bluetooth module for supporting Bluetooth communication;
a memory unit for storing data received through the Bluetooth module; and
a control unit for forwarding the received data to a target Bluetooth device selected depending on preset forwarding information in a forwarding mode.

12. The device of claim 11, wherein the control unit controls the data forwarding for at least one of the target Bluetooth device, depending on a forwarding type based on the forwarding mode.

13. The device of claim 12, wherein the control unit controls the data forwarding for a plurality of the target Bluetooth devices according to at least one of a forwarding priority and a random selection.

14. The device of claim 12, wherein the control unit controls at least one of the data forwarding for at least one of a plurality of the target Bluetooth devices from one target Bluetooth device with a first priority to another target Bluetooth device with a last priority and a specific Bluetooth device selected from the plurality of the target Bluetooth devices.

15. The device of claim 12, wherein the forward type comprises at least one of a batch forwarding type and sequential forwarding type.

16. The device of claim 11, wherein the control unit controls to release the Bluetooth connection from the second Bluetooth device at the first Bluetooth device, transmit a request for a new Bluetooth connection to a specific Bluetooth device selected depending on the forwarding information, and forwards the received data to the specific Bluetooth device when receiving a response signal from the specific Bluetooth device.
